(19) United States
(12) Patent Application Publication
(10) Pub. No.: US 2006/0038318 A1
(43) Pub. Date: Feb. 23, 2006

(54) A method and process of manufacturing an artificial nail blank

(76) Inventors: Scott L. Nielson, Layton, UT (US); Craig P. Gifford, West Jordan, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/711,019

(22) Filed: Aug. 18, 2004

(51) Int. Cl. B29C 45/14

(52) U.S. Cl. 264/248; 264/328.8

(57) ABSTRACT

The invention is a method and process to manufacture an artificial nail blank by injecting raw material into a mold. The nail blank may be comprised of plastic, metal or ceramics. An obvious design would permit the manufacture of the blank to accommodate one artificial nail, or any number of digits. The blank may be a solid color or may have multiple colors contained within it. Multi colored blanks may have specialized artistic designs to accommodate a french-nail look where the color is found to imitate the curve a natural nail tip and where the color is consistent throughout the blank. The application of the invention results in a wide scope of possible implementations including a use for creating artificial fingernails and artificial toenails.

### BACKGROUND OF INVENTION

Necessity is the mother of invention in this case. While working in the artificial nail industry trying to invent and develop safe products, the inventors determined that a nail blank just didn't exist in a manner that would be conducive to the overall goals and ambitions of the inventors. The inventors are driven to create a better artificial fingernail product. With that goal in mind, the idea is to allow users to wear a better artificial nail composed of a strong durable plastic or even a metal nail, or even combinations of a variety of raw materials. There is no nail blank that satisfies the requirements of the invention in the market. Here the inventors had to experiment with a multitude of ideas and concepts to come up with a method and process that would allow a nail blank to be manufactured, which would later allow for a desired nail object to be cut out of the nail blank, where the artificial nail object is the desired result and final product.

The advantage of this invention is that with relative ease and very little effort a nail blank can now be manufactured that would allow the extraction of a unique and desired artificial nail object. This invention has many applications, particularly with fingernail and toenails.

### SUMMARY OF INVENTION

The invention is a method and process to manufacture an artificial nail blank by injecting raw material into a mold. The nail blank may be comprised of plastic, metal or ceramics. An obvious design would permit the manufacture of the blank to accommodate one artificial nail, or any number of digits. The blank may be a solid color or may have multiple colors contained within it. Multi colored blanks may have specialized artistic designs to accommodate a french-nail look where the color is found to imitate the curve a natural nail tip and where the color is consistent throughout the blank. The application of the invention results in a wide scope of possible implementations including a use for creating artificial fingernails and artificial toenails.

### BRIEF DESCRIPTION OF DRAWINGS

FIG. 1 is a diagram illustrating multiple mold types, further demonstrating the artistic enhancement of a french nail style nail blank.

### DETAILED DESCRIPTION

At first it is required to determine the raw material to be found within the manufactured nail blank. This may be composed of any color and/or combination of plastic, metal or ceramic. Once this is determined, then a decision about the mold is made regarding the desired number and type of individual nail objects to be cut out of the manufactured nail blank. For example, if the decision is to cut out 5 french nail fingernail objects, then a multi-mold reflecting the five individual objects and the artistic design of a french nail would be utilized. The raw material is then forcefully injected into the mold and shaped to the mold. In cases of multiple injections (like the example above), two molds may be used and a process of heating the first mold results and then injecting the second mold material is performed and the instant the material begins to shape to the second mold, a vice or clamp is applied to create a pressure bond with the first mold results. This invention permits a single nail blank to be created out of any number of colors or compositions of raw material with all the characteristics as if only one injection had occurred of a single material, while at the same time maintaining the desired artistic enhancements, thus permitting the creation of some unique and desirable nail objects.

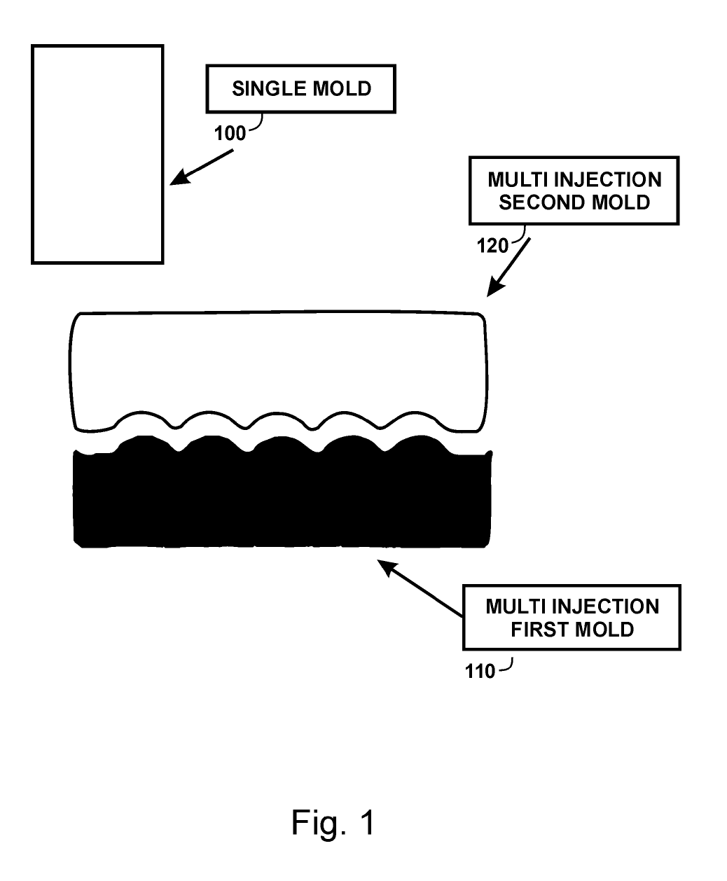

This invention allows a nail blank to be manufactured out of many different types of raw material including plastics, metals and ceramics. The next stage is to determine the mold to be used. This decision can reflect a manufactured nail blank all of one color and material type as shown in FIG. 1. In the single mold 100 choice the mold is injected with the selected material, once the material is shaped to the mold and hardened the nail blank is complete. Injecting the raw material into the mold may be accomplished by injection molding, compression molding, rotational molding, blow molding, or thermoset injection molding.

The mold choice can also lead to a multi-injection process to create the nail blank. Under this choice, two molds may be utilized. Typically, a multi-injection process will be required where some artistic enhancement is desired in the manufactured nail blank. The most common will be the intention to create a french nail look manufactured nail blank, where a curve along the smile line is imitated in the manufactured nail blank. During the multi injection process the first mold 110 is injected with the selected material which may be composed of any of the raw materials. Immediately after the injection and before the first mold 110 results have completely cooled or settled, the second multi injection into the second mold 120 occurs. In order to facilitate bonding between the two raw materials types, the first mold results are heated prior to the injection of the material into the second mold 120. Once the injected material is shaped around the first mold results and the second mold itself, a vice or clamp may be applied to facilitate a pressure bonding. The outcome is a single manufactured nail blank that is fused along the artistic enhanced line so that the manufactured nail blank can be utilized to cut out the eventual artificial nail product.

By completing the steps above, a manufactured nail blank will be achieved. The entire objective of the preferred embodiments of the invention has been to create a simplified method and process to manufacture an artificial nail blank. The application of this invention is extensive and plentiful, as with this invention it will become trivial to manufacture unique and desirable nail blanks quickly and easily. Because of the advantages inherent in this invention it is anticipated that many variants of this invention are possible, which should be included within the preferred embodiments and descriptions of this invention.

1. A method to manufacture an artificial nail blank, comprising:
choosing a desired raw material blank type to manufacture, and;
determining the mold to utilize in the creation of the desired blank, and;
injecting the raw material into the mold, and;
when applicable injecting multiple raw materials into separate molds and fusing the separate mold results together to form one nail blank.

2. The method of claim 1, wherein choosing a desired raw material includes raw materials comprising plastic, metal or ceramics, where;
the plastics may be thermoplastic resin or thermoset types, and;
the metal may be any common metal substance which may be heated to a molten state and then molded, and;
the ceramics include any type of ceramic material including glass, clay or porcelain.

3. The method of claim 2, wherein choosing a desired raw material includes the ability to choose any color or combination of colors. Further, the raw materials may be combined to create very unique nail blank combinations.

4. The method of claim 1, wherein determining the mold to use includes determining if the nail blank will have an artistic enhancement or be all of one consistent color or raw material type.

5. The method of claim 4, wherein an artistic enhancement includes a mold design that conforms to the curvature of the nail tip or appears to allow for the nail blank to permit a nail object to be cut out of the nail blank where the curve of the nail tip appears to be reflected in the mold.

6. The method of claim 4, wherein the artistic enhancement may include customized or personalized designs with regards to the curve of the tip of the nail along the nail free-edge or the smile line.

7. The method of claim 4, wherein one consistent color or raw material type includes a mold that is large enough to cut out an artificial nail object consisting of the entire color or raw material type.

8. The method of claim 1, wherein determining the mold to use includes a decision regarding how many nail objects will be cut out of the manufactured nail blank. This number could be as little as one or as great as five hundred individual nail objects to be cut out of the nail blank.

9. The method of claim 1, wherein determining the mold to use includes allowing up to three inches in width, five inches in length and three inches in height for an individual nail object to be cut out of the manufactured nail blank, thus changing the parameters of the manufactured nail blank to allow for such an object to be successfully removed from it without damaging the nail objects characteristics or intruding upon any other number of individual nail objects to be removed from the manufactured nail blank.

10. The method of claim 1, wherein injecting the raw material into the mold includes applying force to the raw material in a state where the raw material will reshape to conform to the mold selected.

11. The method of claim 10, wherein injecting raw material into a mold may be accomplished by:
injection molding, or;
compression molding, or;
rotational molding, or;
blow molding, or;
thermoset injection molding, or;
any combination of these molding methods.

12. The method of claim 1, wherein multiple injections includes forcing the raw material into the mold for the first injection and then forcing a different raw material into the mold or a second mold to create the desired nail blank.

13. The method of claim 12, wherein forcing a different raw material into the mold or a second mold includes material of the same type but may be distinguished by color, chemical properties, characteristics or other distinguishing factors.

14. The method of claim 1, wherein fusing separate mold results into one manufactured nail blank includes the process of creating a better mating surface of the first mold by heating and/or applying a vice to create heat bonding and/or pressure bonding so that the raw material will merge into the one nail blank result while maintaining any desired artistic enhancement.

15. A process to manufacture an artificial nail blank, comprising:
choosing a desired raw material blank type to manufacture, and;
determining the mold to utilize in the creation of the desired blank, and;
injecting the raw material into the mold, and;
when applicable injecting multiple raw materials into separate molds and fusing the separate mold results together to form one nail blank.

16. The process of claim 15, wherein choosing a desired raw material includes raw materials comprising plastic, metal or ceramics, where;
the plastics may be thermoplastic resin or thermoset types, and;
the metal may be any common metal substance which may be heated to a molten state and then molded, and;
the ceramics include any type of ceramic material including glass, clay or porcelain.

17. The process of claim 16, wherein choosing a desired raw material includes the ability to choose any color or combination of colors. Further, the raw materials may be combined to create very unique nail blank combinations.

18. The process of claim 15, wherein determining the mold to use includes determining if the nail blank will have an artistic enhancement or be all of one consistent color or raw material type.

19. The process of claim 18, wherein an artistic enhancement includes a mold design that conforms to the curvature of the nail tip or appears to allow for the nail blank to permit a nail object to be cut out of the nail blank where the curve of the nail tip appears to be reflected in the mold.

20. The process of claim 18, wherein the artistic enhancement may include customized or personalized designs with regards to the curve of the tip of the nail along the nail free-edge or the smile line.

21. The process of claim 18, wherein one consistent color or raw material type includes a mold that is large enough to cut out an artificial nail object consisting of the entire color or raw material type.

22. The process of claim 15, wherein determining the mold to use includes a decision regarding how many nail objects will be cut out of the manufactured nail blank. This number could be as little as one or as great as five hundred individual nail objects to be cut out of the nail blank.

23. The process of claim 15, wherein determining the mold to use includes allowing up to three inches in width, five inches in length and three inches in height for an individual nail object to be cut out of the manufactured nail blank, thus changing the parameters of the manufactured nail blank to allow for such an object to be successfully removed from it without damaging the nail objects characteristics or intruding upon any other number of individual nail objects to be removed from the manufactured nail blank.

24. The process of claim 15, wherein injecting the raw material into the mold includes applying force to the raw material in a state where the raw material will reshape to conform to the mold selected.

25. The process of claim 24, wherein injecting raw material into a mold may be accomplished by:
injection molding, or;
compression molding, or;
rotational molding, or;
blow molding, or;
thermoset injection molding, or;
any combination of these molding methods.

26. The process of claim 15, wherein multiple injections includes forcing the raw material into the mold for the first injection and then forcing a different raw material into the mold or a second mold to create the desired nail blank.

27. The process of claim 26, wherein forcing a different raw material into the mold or a second mold includes material of the same type but may be distinguished by color, chemical properties, characteristics or other distinguishing factors.

28. The process of claim 15, wherein fusing separate mold results into one manufactured nail blank includes the process of creating a better mating surface of the first mold by heating and/or applying a vice to create heat bonding and/or pressure bonding so that the raw material will merge into the one nail blank result while maintaining any desired artistic enhancement.
